(19) United States
(12) Patent Application Publication
(10) Pub. No.: US 2001/0043697 A1
(43) Pub. Date: Nov. 22, 2001

(54) MONITORING OF AND REMOTE ACCESS TO CALL CENTER ACTIVITY

(76) Inventors: PATRICK M. COX, TIGARD, OR (US); A. PETER POWELL, COLTON, OR (US); MICHAEL A. KEPLER, ALOHA, OR (US); CHRISTOPHER A. HUEY, BANKS, OR (US); JOHN E. GIRSCH, PORTLAND, OR (US); A. SHANNON LEE, PORTLAND, OR (US)

Correspondence Address: WHITE & CASE LLP, PATENT DEPARTMENT, 1155 AVENUE OF THE AMERICAS, NEW YORK, NY, 10036, US

(21) Appl. No.: 09/075,780

(22) Filed: May 11, 1998

(51) Int. Cl. H04M 3/00; H04M 5/00

(52) U.S. Cl. 379/265.06

(57) ABSTRACT

A method of monitoring call center attendants' assistance to callers is provided in which a call monitor is configured to record interaction between attendants and callers. Such interaction may be recorded for all, or substantially all, calls received at a call center. The reviewer optionally specifies criteria concerning calls that are to be recorded. The call monitor connects to a call center switch after a call attendant logs in. When the attendant receives a call matching the specified criteria, if any, the call monitor records interaction the attendant and the caller to create a call record. In a present embodiment of the invention, the call record is stored on the call monitor in compressed digital format. To replay a call record, the reviewer connects to a web server or other interface through an internetwork connection. From the web server the supervisor selects a call record to be played. The call monitor plays the call recording via streaming audio, across the internetwork connection, on the reviewer's computer.

### BACKGROUND OF THE INVENTION

1. Technical Field

The present invention relates to the field of telecommunications. In particular, methods and a system are provided for the remote monitoring of calls handled by a call center attendant located at a call center.

2. Discussion of Related Art

Call centers are designed to provide various types of assistance to customers. One call center may provide technical support to purchasers of a software vendor's products, while another may provide directory assistance to telephone subscribers. Regardless of the nature of a call center, one of its primary activities is to provide instructions, guidance, or information to callers. An organization operating a call center naturally has an interest in providing assistance that is timely, useful, and accurate, and which is given in a courteous manner. To that end, the organization often reviews or monitors the attendants' performance in one way or another.

One manner in which an attendant may be monitored is to telephonically connect a call center attendant's local supervisor or other reviewer to the same call to which an attendant is connected. By monitoring the call, the reviewer can evaluate the attendant's manner, attitude, effectiveness, accuracy, and any other desired traits, as the attendant is working. A shortcoming of this type of supervision, however, is that a reviewer can only connect to one call at a time and can only monitor an attendant's performance while that attendant is on duty. In addition, the reviewer usually must be located within the same call center as the attendant.

Accordingly, there is a need in the art for means and methods by which to monitor a call handled by a call center attendant either during the attendant's interaction with the caller or at some time after the interaction occurs. There is also a need for a method of remotely reviewing a call center attendant's performance. Further, a call handled by a specified attendant may need to be reviewed on more than one occasion and/or by more than one supervisor or other reviewer.

### SUMMARY OF THE INVENTION

In view of the disadvantages of the related art, it is an object of the present invention to provide a method and apparatus for recording a call center attendant's interaction with one or more callers.

It is a further object of the present invention to provide for remote retrieval and playing of recorded calls.

It is also an object of the invention to provide for monitoring of a call center attendant's interaction with a caller in real-time, during the caller's connection to the call center.

It is yet a further object to classify call recordings for efficient storage and/or retrieval.

In accordance with one embodiment of the present invention, a call monitor within a call center records interaction between one or more call center attendants and callers connected to those attendants. The call monitor is configured to record attendant/caller interaction for all, or substantially all, calls received at the call center. Alternatively, the call monitor may be configured to record only calls matching certain criteria.

In a present embodiment, the call monitor only records the portions of calls during which a call center attendant interacts with the caller. Thus, in this embodiment neither the greeting nor the closing message is recorded, nor is the caller's connection to a destination party recorded, unless the attendant is connected to the call during that time.

When a call is received at the call center, the call monitor is informed that an assigned call center attendant is about to converse with the caller. The call monitor is illustratively given this information by a voice server or a switch within the call center. The call monitor then begins recording the call. The recording is stored on the call monitor and is categorized by indicia that identify the call (e.g., call center; call center attendant; date, time, duration of call; telecommunication service provider; identity of caller; origination of call). In a present embodiment, key indicia are included in the name of a file in which the recording is stored. In other embodiments, the indicia are stored in a database entry corresponding to the call recording or are incorporated into other means of identifying the recording. Call recordings are compressed, in one embodiment of the invention, in order to conserve storage space on the call monitor.

The call monitor continues recording the call until informed that the caller or attendant has disconnected, such as after the call center attendant dials a destination number for the caller and clears out of the call. An extended period of silence may also indicate that the call has been terminated, in which case the call monitor ceases recording.

A reviewer, at some later time, wishes to review one or more recordings of calls handled by a call center attendant. The reviewer may, illustratively, be the call center attendant's supervisor, a representative of a customer service provider, or other entity authorized to review the interaction between an attendant and a caller. The reviewer first connects to a web server or other suitable interface, which may be located internal or external to the call center. The interface allows the reviewer to access call recordings stored on the call monitor via a web browser or other interface. The interface may, for example, provide speech recognition, speech-to-text conversion, text-to-speech conversion, information displayed on the call center attendant's terminal during the call, etc. The interface enforces a security scheme to control access to the call recordings, at least where the interface is external to the call center. The security scheme allows some reviewers, an attendant's supervisor for example, to review all recordings on the call monitor, while others, such as a representative of a telecommunications service provider, are limited to retrieving a subset of all recorded calls.

Once the reviewer has accessed the call recordings via the appropriate interface, he or she selects a call recording to be played. The selection may be based upon a particular call center attendant and/or any other desired criteria (such as those listed above). The reviewer may, for example, select a specific call recording based the contents of its file name, the contents of an associated database entry, etc.

In one embodiment of the invention, the call monitor then plays the call recording via a streaming audio feed that is received and played for the reviewer on the reviewer's computer. In alternative embodiments, a call recording is delivered to the reviewer's computer by file transfer or other means of delivery. By using a streaming audio feed, however, the reviewer need not wait while the call recording is downloaded to his or her computer.

### BRIEF DESCRIPTION OF THE DRAWINGS

These and other features, objects, and advantages of the present invention will become more readily apparent from the following detailed description, which should be read in conjunction with the accompanying drawings, in which:

FIG. 1 depicts a wide area environment in which one embodiment of the invention may be practiced;

FIG. 2 depicts the components of an illustrative call center according to one embodiment of the invention;

FIG. 3 depicts an illustrative telephone switch suitable for use within the call center of FIG. 2;

FIG. 4 depicts an illustrative voice server of a call center according to the embodiment of FIG. 2;

FIG. 5 depicts an illustrative call monitor of a call center according to the embodiment of FIG. 2;

FIG. 6 is a flowchart demonstrating one method of recording call center activity;

FIG. 7 is a flowchart demonstrating an alternative method of recording call center activity;

FIG. 8 is a flowchart demonstrating one method of providing remote access to recorded calls; and

FIG. 9 is a flowchart demonstrating one method of remotely monitoring, in real-time, a call center attendant's interaction with a caller.

### DETAILED DESCRIPTION OF THE INVENTION

The following embodiments are described in the context of a call center providing directory assistance services. Those skilled in the art, however, will recognize that the disclosed methods and structures are readily adaptable for broader applications, such as call centers providing other informational or technical assistance.

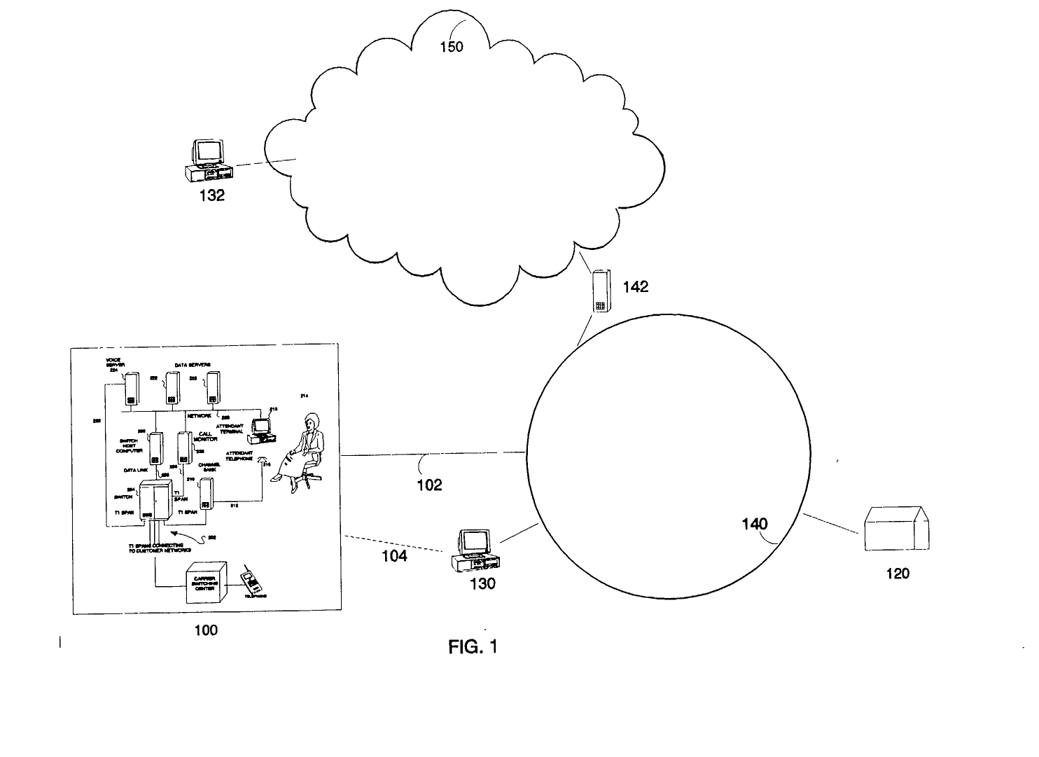

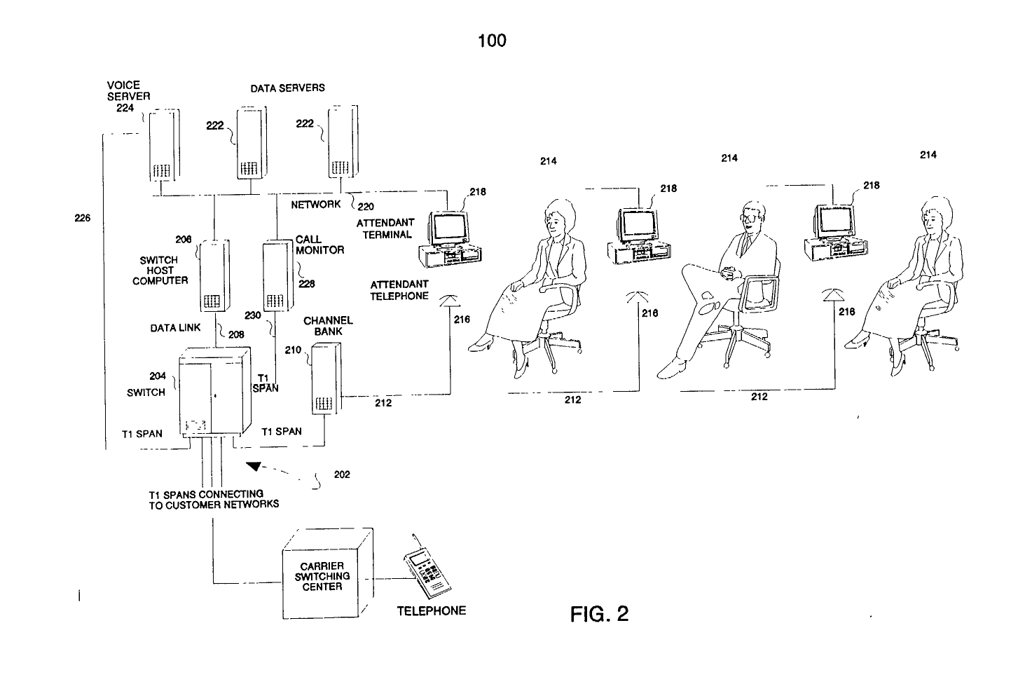

With reference now to FIG. 1, an illustrative environment is depicted in which the present invention may be implemented. Call center 100 is a representative call center, the structure of which is described in detail below in conjunction with FIG. 2. A second call center 120 is also depicted in FIG. 1 and may or may not be similar in structure to call center 100 as shown in FIG. 2.

Network 140, which in one embodiment of the invention is a Wide Area Network (“WAN”), serves one or more call centers. WAN 140 is electrically connected to call center 100 by communication link 102. Communication link 102 is, illustratively, an internetwork connection but may alternatively comprise a dial-up link such as that provided by a modem. In the illustrated embodiment, WAN 140 also serves one or more reviewer computers. A first reviewer computer 130 is operated by a call center supervisor or a representative of a customer service provider in order to monitor or review the performance of a call center attendant in call center 100. Reviewer computer 130 may, alternatively, be part of another call center or network not pictured in FIG. 1.

Internet (or WAN) 150 is, in the illustrated embodiment, electrically connected to WAN 140 via gateway 142. Another reviewer computer 132, which may be part of a network, may also be connected (directly or indirectly) to internet/network 150. Gateway 142 controls or filters access to WAN 140 and call recordings stored in call centers connected to WAN 140. In this embodiment, gateway 142 comprises a web server or other apparatus providing internetwork access, a call monitor interface, and security features with which control access to call center 100 from computers such as reviewer computer 130 and/or reviewer computer 132.

In an alternative embodiment of the invention, network 150 is an intranetwork connecting additional call centers and/or reviewer computers to WAN 140. In another alternative embodiment, reviewer computer 130 and/or reviewer computer 132 connect directly to call center 100. In yet a further alternative embodiment of the invention, a reviewer computer is part of an internal network (depicted in FIG. 2) within call center 100.

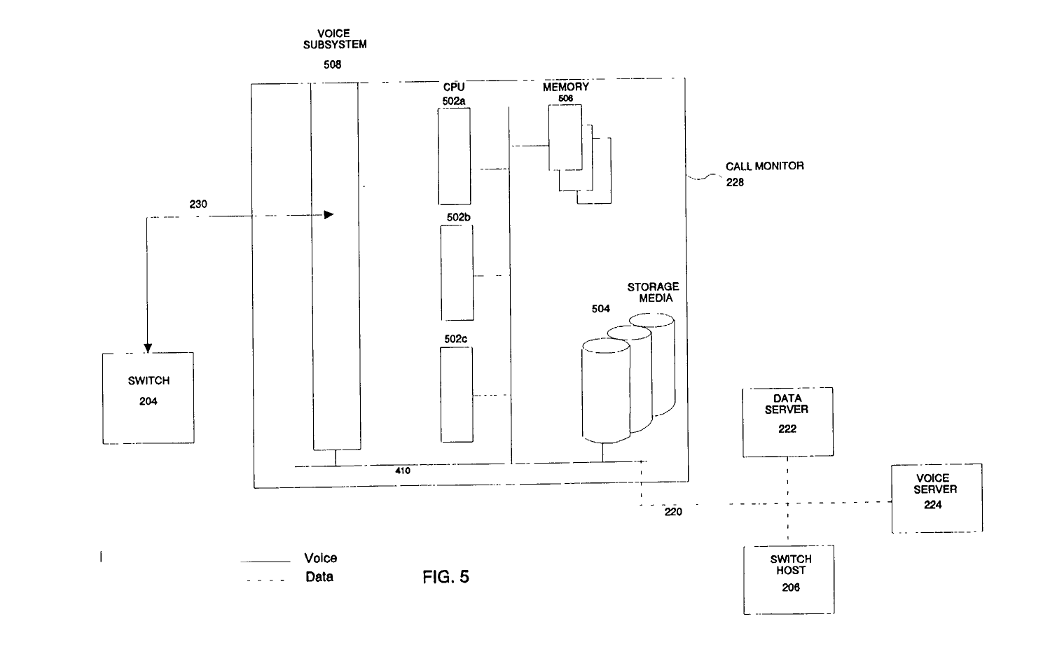

Reviewer computers 130, 132 execute suitable operating systems (e.g., Windows 95, Windows NT, Macintosh OS, Unix, Solaris) and appropriate application software (e.g., Internet Explorer, Netscape Navigator, RealAudio, WinFrame, Direct Audio, Qualcomm's CDMA audio streaming program—is this “PureVoice?”), including multimedia applications where necessary, to permit a reviewer to access a call monitor within call center 100. Call monitors are discussed in detail below with reference to FIG. 5 and are employed in the presently illustrated embodiment of the invention to record and play call center attendants' interaction with calling customers.

Call recordings are illustratively created by a call monitor in call center 100 for all or selected calls handled by the call center's attendants. The call monitor is connected to the call center's switch and is configured in a present embodiment of the invention to record all calls, or substantially all calls, that involve interaction between a caller and a call center attendant. In an alternative embodiment, the call monitor is configured to record only calls meeting specified criteria.

The various factors and criteria that may be used to specify the calls to be recorded, and/or the call recordings to be retrieved for review, illustratively allow the identification of calls based on: caller or originating telephone (e.g., via MIN, ANI, ESN); geographic origination of the call (e.g., city); telecommunications carrier; time or range of time; date or range of dates; duration of call; call center; call center attendant; random selection; or a combination of the preceding. Additionally, when retrieving call recordings, a single recording or multiple recordings may be retrieved.

In an illustrative sequence of events according to a present embodiment of the invention, a directory assistance call is received by a switch within call center 100. Using automatic call distribution (“ACD”) logic, a call center attendant is assigned to provide assistance to the caller.

In an embodiment of the invention in which the attendant's customer interaction is to be monitored in real-time, a reviewer at reviewer computer 130 or 132 is alerted that a call is about to be handled by the assigned attendant. The reviewer accepts a connection to the call monitor and the attendant/caller interaction is received (e.g., via a streaming audio feed or text-to-speech conversion that is played on a speaker connected to the reviewer's computer). Alternatively, the interaction may be converted from speech to text and displayed on the reviewer's computer. In this alternative, multiple attendants' interaction with customers may be displayed at once, and a text search tool may be used to monitor the interaction for key words or phrases.

In an embodiment of the invention in which the attendant/caller interaction is to be recorded for later review, before the caller and attendant begin to converse (or shortly thereafter) the call monitor is conferenced into, and begins recording, the call. The call monitor records all or a portion of the interaction between the call center attendant and the calling customer. The call monitor, in the present embodiment, stores the recorded call locally in compressed digital form in order to minimize the necessary storage space. In alternative embodiments, recorded calls may be stored in another suitable form and/or at a location other than the call center in which the attendant is located.

In order to play a recorded call, a reviewer (e.g., a call center supervisor or other authorized party, such as a representative of a service provider) accesses the call monitor as described shortly below and selects a call recording or specifies criteria pertaining to one or more call recordings. A desired call recording is then played or delivered by the call monitor through the party's connection. Various illustrative criteria that are used to classify and select call recordings are listed above.

For selection and playback of a call handled by an attendant in call center 100, for example, a reviewer illustratively operates reviewer computer 132 to connect through internet 150 to gateway 142. Gateway 142, in this embodiment, comprises a web server and is connected via WAN 140 to a network within call center 100 through which the call monitor can be accessed. Gateway 142 in this embodiment serves as a point of access for all, or substantially all, call monitors within the call centers connected to WAN 140. One of skill in the art will understand, though, that multiple gateways may be employed in place of the single gateway depicted in FIG. 1, perhaps being located between WAN 140 and each connected call center.

Gateway 142 enforces a security scheme, such as user accounts with associated passwords, in order to control authorized access and prevent unauthorized access to call recordings. Gateway 142 may be part of the internal network within a call center such as call center 100, but, in the illustrated embodiment is external to the call center in order to further enhance call center security and the integrity of the call recordings. In the illustrated embodiment, gateway 142 is a “firewall” between WAN 140 (and the connected call centers) and the internet 150.

Through the interface (e.g., a web browser) provided by gateway 142, a desired call recording stored on a call monitor within call center 100 is selected and played on computer 132, possibly via a streaming audio feed. For the purpose of playing recorded audio, computer 132 includes speakers, headsets, a speech-to-text converter, or other means for interpreting the recording into a form intelligible to the reviewer. When using a streaming audio feed, the call recording played on computer 132 generally is not stored on computer 132. As the audio feed is received from the call monitor it is simply decompressed and translated, as necessary, and played. In another embodiment, however, the call recording is delivered to reviewer computer 132 via file transfer, text-to-speech, etc. Text-to-speech conversion is useful, for example, in reviewing calls in which the attendant and caller interact via TTY.

A call center may advantageously employ multiple call monitors. With multiple call monitors, one may be configured to record calls while another compresses recordings, provides access to stored call recordings, and performs storage and playback functions.

In an alternative embodiment, a supervisor at reviewer computer 130 accesses call center 100 through communication link 104, illustratively a dial-up link connected to the call center's internal network. In this embodiment, the supervisor may access the call monitor and its stored call recordings through a web server or other interface local to call center 100. The supervisor may, in yet a further alternative, connect directly from reviewer computer 130 to gateway 142, without traversing WAN 140.

In other alternative embodiments of the invention, selected customers or service providers of call center 100 are granted access from reviewer computer 132, through network 150 and gateway 142, in order to play an authorized subset of call recordings made by a call monitor in call center 100.

With reference now to FIG. 2, call center 100 according to an exemplary embodiment of the invention is depicted. One or more external communication links 202 connect call center 100 to callers and customer telephone networks. Communication links 202 connect to switch 204 which is connected to switch host computer 206 via switch data link 208. In an alternative embodiment, switch host computer 206 is coterminous with switch 204.

Switch 204 is attached via a T1 communication link to channel bank 210 and from there connects to attendant channel 212 and attendant telephone 216. Attendant telephones are located at each of one or more attendant positions (represented by the numeral 214 in FIG. 2). Using attendant data terminal 218, a live attendant at attendant position 214 accesses one or more data servers 222 and/or voice servers 224, which are inter-connected via network 220. Switch host computer 206 and call monitor 228 are also connected to network 220, with call monitor 228 being connected directly to switch 204 by call monitor link 230. In a present embodiment of the invention, call monitor link 230 is comprised of one or more T1 links. Finally, switch 204 is connected to one or more voice servers 224, which are described below. Each connection to a voice server illustratively employs a T1 voice server link (a first voice server link 226 is shown in FIG. 2).

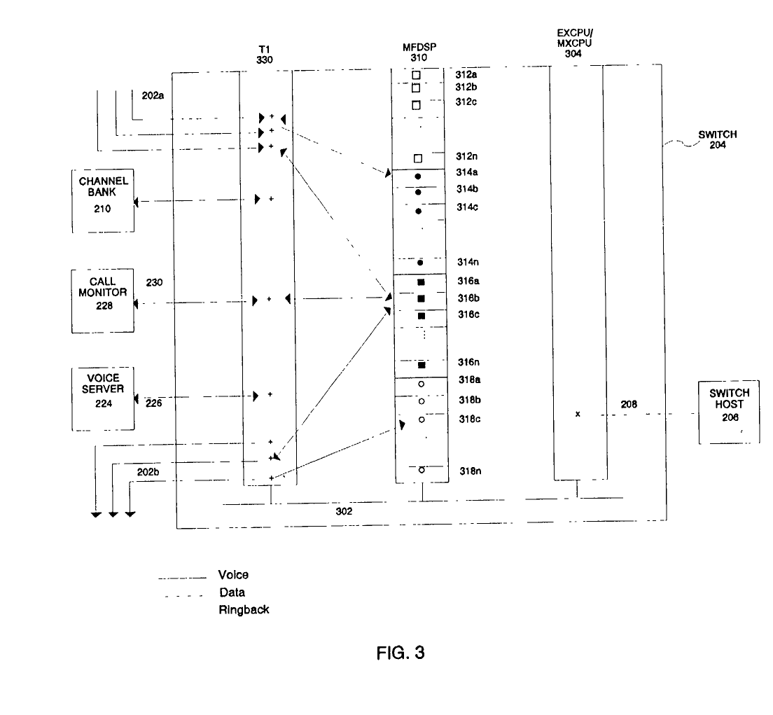

As stated above, communication links 202 provide telephone connections to call center 100 for incoming directory assistance calls and also provide access to external telephone networks over which outgoing calls are placed. An incoming call is received via inbound channel 202a (shown in FIG. 3) and an outgoing call is placed over outbound channel 202b (shown in FIG. 3). There is generally one outbound channel 202b for every inbound channel 202a, so that for every call into call center 100 there is an outbound channel available to reach the caller's desired party or parties. Communication links 202 may, in an illustrative embodiment, be comprised of one or more T1 communication spans. In such an embodiment, each individual call over a T1 span, whether into or out of switch 204, utilizes one of the 24 individual channels into which a T1 span is segmented, each channel providing two-way communication. The embodiments of the invention described below refer to links 202 as standard T1 links although one skilled in the art will recognize that other communication links, such as Common Channel Signalling System 7 (“CCSS7”) or Integrated Services Digital Network (“ISDN”), may be used.

Switch 204 is now described in further detail with reference to FIG. 3. Operation of switch 204 is governed by computer-readable instructions stored and executed on switch host computer 206. In one embodiment of the invention, switch 204 is an Excel LNX 100 and switch data link 208 is a 38.4 kb serial link; in another embodiment, switch data link 208 is an Ethernet link.

Switch 204 includes expandable central processing unit (“EXCPU”) and/or matrix central processing unit (“MXCPU”) 304. EXCPU/MXCPU 304 serves as a data interface for switch 204 to switch host computer 206 (via switch data link 208).

EXCPU/MXCPU 304 and other components of switch 204 communicate through shared communication path 302, commonly called a “midplane.” In the currently-described embodiment, midplane 302 utilizes a time division multiplexing (“TDM”) method of sharing a common pathway. Thus, a plurality of data and/or voice streams can be interlaced onto the single path, separated by time.

Another board-level component of switch 204 is multi-frequency digital signal processor (“MFDSP”) unit 310, which includes four single in-line memory module (“SIMM”) packagings. Each SIMM packaging is comprised of four DSP arrays. Each DSP array is composed of multiple, illustratively sixteen, programmable DSPs. The DSPs can be programmed or reprogrammed to function as, among other things, call progress analyzers (“CPA”), call progress generators (“CPG”), multi-frequency (“MF”) receivers or transmitters, dual-tone multi-frequency (“DTMF”) receivers or transmitters, or conference units, depending upon the demand placed on call center 100 and switch 204 for each corresponding function.

CPAs (represented by the numeral 318 in FIG. 3) are sensitive to, and capable of identifying, telephone connection status conditions and signals including ring tone, busy, reorder, PBX intercept, SIT intercept, vacant code, reorder-SIT, no circuit LEC, reorder-carrier, no circuit-carrier, dial tone, continuous on tone, and silence. In an exemplary embodiment of the invention, one CPA will monitor only one outbound channel 202b at a time. In other embodiments of the invention, one CPA may be applied to more than one outbound channel. However, to ensure that connection status conditions are properly detected, the number of outbound channels monitored by one CPA should be kept to a minimum (i.e., no more than four). In still other embodiments of the invention, two or more DSPs may be applied to a single outbound channel.

CPGs (represented by the numeral 312 in FIG. 3) generate tones to customers connected to call center 100, such as the ringback tone customers hear when they are routed to an attendant.

DTMF receivers (represented by the numeral 314 in FIG. 3) listen for DTMF tones generated by customers' telephones, such as when a customer presses a telephone button. DTMF receivers are capable of detecting and identifying which button was pressed (i.e., the numbers 0-9 or the characters ‘*’ or ‘#’) and passing that information to switch host computer 206 for appropriate action. DTMF receivers are assigned to monitor inbound channels for a configurable period of time, illustratively, from the time of a caller's initial connection to switch 204 until the caller disconnects, including the duration of all outbound call legs made on the caller's behalf. Once applied to an inbound channel, a DTMF receiver allows switch 204 to detect the press of a telephone button, perhaps in order to activate a tone-triggered return transfer as described in U.S. Pat. No. 5,737,700, which is incorporated herein by reference, or another feature of call center 100.

Conference units (represented by the numeral 316 in FIG. 3) enable switch 204 to connect two or more voice paths in a balanced manner, thereby providing the necessary voice connections between calling parties, called parties, call attendants, reviewers and/or call monitor 228.

In the presently-described embodiment, each DSP array provides multiple instances of the function for which it is programmed, the exact number depending upon the specific function. For example, each DSP array programmed to provide CPA, CPG, or DTMF receiver functions provides sixteen instances of the chosen function. In other words, a DSP array programmed to provide call progress analyzer functions will contain sixteen separately and independently functional and controllable CPAs. A DSP array programmed to provide conference unit functions, however, provides only four instances of such function. The programmable DSPs on MFDSP unit 310 are managed by switch host computer 206 via EXCPU/MXCPU 304, which keeps track of which DSPs are available and which are allocated.

An additional board-level component of switch 204 is T1 interface unit 330. Switch 204 contains one or more T1 interface units; each unit provides connections to eight T1 (1.544 mb/sec) spans, each of which is comprised of 24 channels, thus providing 192 64 kb voice channels per T1 interface unit. In FIG. 3, T1 interface 330 dedicates twelve channels on each of six of the eight spans to incoming calls and the other twelve to outgoing calls. The seventh and eighth T1 spans provide voice server link 226, call monitor link 230, and the link to channel bank 210 and operator channel(s) 212. Voice server link 226 and channel bank 210 are used to connect directory assistance callers to a voice server or a live call center attendant, respectively. Call monitor link 230 connects call monitor 228 to switch 204 in order to monitor or record calls.

It will be recognized by one skilled in the art that multiple instances of switch 204 may be incorporated into a telephone network or call center 100 without exceeding the scope of this invention.

Referring now to FIG. 2 again, switch host computer 206 stores and executes computer-readable instructions for the purposes of, among others, configuring and operating switch 204 and directing the transfer of calls through switch 204. It also directs the playback of recorded messages, such as greetings and closings, to callers connected to call center 100. Pre-recorded greeting and closing messages played for callers are illustratively recorded in the voice of the attendant to whom the caller will be, or was, connected. Switch host computer 206 directs the playback of the appropriate message by identifying the attendant and the inbound channel 202a the caller is connected to and specifying the message to be played.

Further, switch host computer 206 maintains call data for each directory assistance call connected to call center 100. The call data stored on the host computer consists of the most recent assistance request received from each caller, and includes one or more of: the calling telephone number, the date and time of the caller's connection to call center 100, the T1 span and channel the caller is connected to, the caller's desired destination telephone number, the status of the caller's previous directory assistance request, which attendant assisted the caller, etc. Additional call data is stored on the data servers, as described below. The call data stored on switch host computer 206 and the data servers are provided to call center attendants when a caller makes multiple directory assistance requests in one call to call center 100. By considering the collected call data, such as the information that was provided to a caller in a previous request, a call center attendant can tailor subsequent assistance to be more effective.

In one embodiment of the invention, switch host computer 206 communicates with call monitor 228 in order to keep the call monitor apprised of the status of calls handled by the call center. For example, switch host computer 206 may inform call monitor 228 when a call is connected to a call center attendant, notify call monitor 228 when the attendant is about to speak with a caller, alert call monitor 228 when the attendant disconnects from a call, etc. Based on the information received from switch host computer 206, call monitor 208 determines when to start and stop recording and learns some of the information with which to identify a call recording (e.g., the call attendant handling the call, the service provider, origination of the call, caller identity, identity of destination party, which communication line the call was received on). In alternative embodiments of the invention, this information is provided by voice server 224 or switch 204, or any combination of the three devices.

Attendant position 214 includes means by which a call center attendant receives calls, determines callers' informational needs, searches for and retrieves information from the data servers, provides information to callers, and initiates outgoing calls. In an exemplary embodiment of the invention, an attendant at attendant position 214 is provided with a telephone headset 216 for interacting with callers, and data terminal 218, connected to network 220, for interacting with the data servers.

Data server(s) 222 and voice server(s) 224 are interconnected via network 220. Data servers 222 provide and manage data services within call center 100 and maintain databases containing telephone and business directories, billing information, and other information in computer-readable form to be searched by attendants in response to callers' requests. As introduced above, data servers 222 also store call data for later retrieval by call center attendants furnishing subsequent assistance to a caller. The call data stored on data servers 222 illustratively include how and where a call center attendant searched for information to satisfy a customer request, the information retrieved by the attendant, how that information was displayed for the attendant, and the form in which it was communicated to the caller. Data servers 222 save call data concerning all requests made by a caller during one call to call center 100, not just the most recent request, but only for a pre-determined period of time (illustratively, one hour).

Billing information is stored in the form of billing records, which are created for each customer call into call center 100. They contain data such as the caller's telephone number, the date and time of the caller's connection to call center 100, the dates and times of attempted connections to destination parties, the duration of each call leg, etc. A billing record is updated each time directory assistance is rendered to the associated customer, and is closed when the customer disconnects from call center 100.

The software used to create and manipulate databases on data servers 222 allows call center attendants to search the databases by name, address, type of goods or services, geographical region, etc. In FIG. 2, switch host computer 206 and data servers 222 are depicted as distinct entities; in an alternative embodiment they are coterminous.

Voice servers (a first voice server 224 is shown in FIG. 2) provide, in alternative embodiments of the invention, all or a subset of the functions provided by a live call center attendant at attendant position 214. For example, voice servers deliver messages that live attendants would otherwise be required to frequently repeat for callers, such as greetings, closing messages, and the caller's requested telephone number.

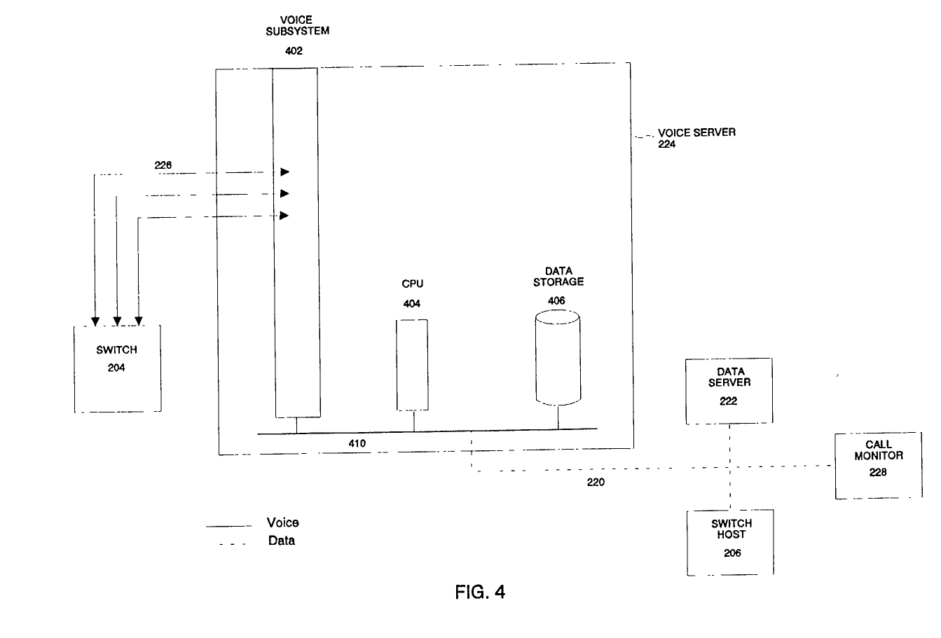

In an illustrative embodiment, depicted in FIG. 4, voice server 224 is connected to switch 204 by voice server link 226 and to switch host computer 206, data servers 222, and call monitor 228 via network 220. Each voice server connects to telephone switch 204 via a separate voice server link. Voice server 224, in a present embodiment, consists of a general purpose computer plus one or more voice subsystems (a first voice subsystem 402 is depicted in FIG. 4). Voice subsystem 402 monitors and controls communications over voice server link 226; its capabilities include telephone tone detection and generation, voice recording and playback, and call progress analysis. Therefore, similar to switch 204, voice server 224 is capable of detecting connection status conditions, detecting customer keypresses, and generating tones. Although FIG. 2 depicts voice server 224 distinct from data servers 222, in alternative embodiments they are coterminous.

Voice server 224 also includes typical computer components such as central processing unit (“CPU”) 404, data storage unit 406, and bus 410 for transferring voice and data signals.

Voice server link 226 provides voice connections between switch 204 and voice server 224, thus providing means by which callers may be connected to voice server 224 and receive automated attendant assistance. Voice server link 226, in an illustrative embodiment of the invention, is comprised of one or more T1 spans, with each one of the 24 channels of each span providing two-way communication.

An illustrative call monitor 228 is depicted in FIG. 5. Call monitor 228 incorporates multiple CPUs 502 (three are depicted in FIG. 5), a large disk array 504, random access memory (“RAM”) 506, and voice subsystem 508. CPUs 502 are illustratively of the INTEL 80x86 or Pentium families, but any comparable processors providing signal processing, compressing, and playback capabilities are suitable. Disk array 504 provides an abundance of storage space (e.g., in excess of thirty gigabytes) in which to store recorded calls. RAM 506 also comprises a large storage space (e.g., in excess of one hundred megabytes) for use in compressing and/or decompressing call recordings and for temporary storage when recording or monitoring calls and when playing recorded calls. Voice subsystem 508 provides a connection to switch 204 for monitoring connected calls. Finally, call monitor link 230 connects call monitor 228 to switch 204. Although multiple CPUs, disks and memory units are depicted in FIG. 5, it is understood by one of ordinary skill in the art that individual instances may be employed in an alternative embodiment.

Call monitor 228 records calls and plays them back for supervisors, quality control personnel, trainers, and other authorized reviewers (e.g., selected customers or service providers). Call monitor 228 also provides real-time monitoring of attendant/caller interaction to connected reviewers. In a real-time mode of operation, a connected reviewer selects a call to which call monitor 228 is conferenced and the call monitor transmits the interaction to the reviewer as it occurs (e.g., via a streaming audio feed).

In a present embodiment, call monitor 228 is configured to record attendant/caller interaction in all, or substantially all, calls received by attendants within call center 100. In one advantageous mode of this embodiment, call monitor 228 begins recording a call after a greeting is played or just as the caller and attendant are about to interact. Call monitor 228 continues recording in this mode until one or the other of the caller or the attendant disconnect from the call. In this mode, greeting and closing messages (which are generally uniform for all calls handled by a particular attendant) are not recorded for each call. Instead, an identifier or pointer to the greeting or closing message that was played is stored with each call recording so that it can be reviewed if desired.

In another embodiment, a person authorized to record calls with call monitor 228 connects or logs into call monitor 228 through network 220, specifies one or more attendants whose calls are to be recorded, and optionally specifies additional criteria identifying calls that are or are not to be recorded. Optional criteria include the telephone number of a caller or destination party; an identification number of the caller's telephone (such as the MIN or ANI); a particular telecommunications service provider; the call center; a geographical area (e.g., a city); date; time; duration of the call; a combination of any of the preceding; etc. If dates and/or times are used as criteria, ranges may be specified. The selected criteria may be used to construct the name of a file in which the call is recorded. Or, the criteria may be stored in a database entry or other storage area associated with the recorded call.

In this alternative embodiment, call monitor 228 is alerted by voice server 224 or switch 204, via network 220 or call monitor link 230, respectively, when the specified call attendant connects to switch 204 (e.g., at the beginning of the attendant's work shift). Call monitor 228 then logs into switch 204 through call monitor link 230. When call monitor 228 detects or is informed that the attendant is about to converse with a caller, it creates a new call recording file and starts recording the call. Call monitor 228 later determines, or is informed, that the call attendant's interaction with the caller is completed and therefore ceases recording and closes the call recording file. Illustratively, the end of the attendant's interaction is signalled by the call attendant's dialing of a destination number (to which the caller wishes to be connected) and clearing from the call, or by the caller hanging up.

When it cannot be clearly determined when the call attendant finishes assisting a caller, the call monitor may continue recording until the calling customer hangs up or until an extended period of silence is detected. The call monitor's length of recording may also be limited in that it will record a call only for a certain amount of time (e.g., up to ten minutes).

Calls recorded by call monitor 228 are available for review by call center supervisors and other authorized reviewers. A reviewer may use computer 130 to connect to call monitor 228 and select either a specific call recording (e.g., by its file name) or certain criteria concerning calls that the reviewer wants to review. A call recording satisfying the reviewer's needs is then played across the connection and through the reviewer's computer. Call recordings are illustratively retained for a period of time and then deleted. Alternatively, they may simply be moved to off-line storage devices.

In FIG. 2, switch host computer 206, data server 222, voice server 224, and call monitor 228 are distinct entities. In alternative embodiments of the invention, however, any or all of them are coterminous. In particular, in a present embodiment voice server 224 and call monitor 228 are interchangeable. From the preceding descriptions of voice server 224 and call monitor 228, it can be seen that one may be configured to perform the other's functions. It is apparent to one of ordinary skill in the art, however, that a large amount of storage space and processing capability is required in order to adequately perform the functions of call monitor 228. When call center 100 includes more than one component capable of acting as call monitor 228, its functions may be divided between the multiple components. One component may, for example, perform all call recording duties while another component handles compression, storage, playback and/or other functions.

Recording Calls According to One Embodiment of the Invention

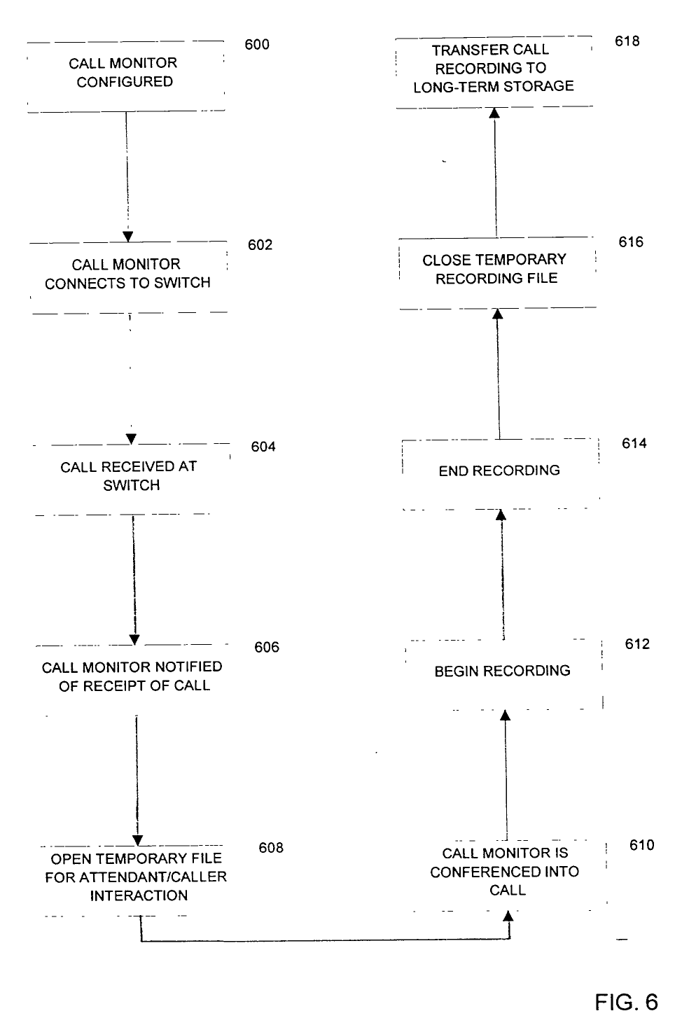

FIG. 6 depicts one method of using call monitor 228 to record calls received by call center 100.

In step 600 call monitor 228 is configured to record attendant/caller interaction for all, or most, calls received by call center 100. Criteria such as those listed above may be selected to determine which calls are to be recorded.

Once configured, or while it is being configured, call monitor 228 connects (step 602) to switch 204. When a call (meeting the specified criteria, if any) is received (step 604) at the switch, call monitor 228 is informed (step 606). Call monitor 228 may, illustratively, be informed of the call arrival by switch 204, switch host computer 206, or voice server 224. When informed of the call, the call monitor is notified of the channel through which the caller is connected.

A temporary file is opened (step 608) on call monitor 228 for storage of the attendant/caller interaction as it occurs. When later stored in a more permanent location, the call recording will, in the illustrated embodiment, have a filename including one or more indicia characteristic of the call (e.g., caller identification, attendant, call center, origination of the call, date and/or time of call, duration of call, service provider). The long-term call recording may, alternatively, be associated with a database entry or other storage area containing the call characteristics. The temporary file, however, is simply used to receive the interaction as it occurs (and before all the relevant indicia can be determined—such as the length of the call).

Call monitor 228 is then conferenced (step 610) into the call. The conference connection may be one-way, in that the attendant/caller interaction is received by the call monitor but the call monitor cannot transmit to the attendant or caller.

Call monitor 228 then begins recording (step 612) the interaction in the temporary file. During the interaction, the attendant provides directory assistance as he or she does normally. Advantageously, only the portion of the call in which the attendant and caller are both connected is recorded. Once the caller hangs up or the attendant clears out of the call (after transferring the caller to a destination party for example), the interaction is considered complete.

When the interaction ceases, or an extended period (e.g., five minutes) of silence is detected, the recording stops (step 614). The temporary file is then closed (step 616).

In an embodiment in which call recordings are stored in compressed form, the recorded interaction is compressed (using any of the numerous known algorithms, for example) as it is transferred (step 618) to long-term storage.

Recording Calls According to a Second Embodiment

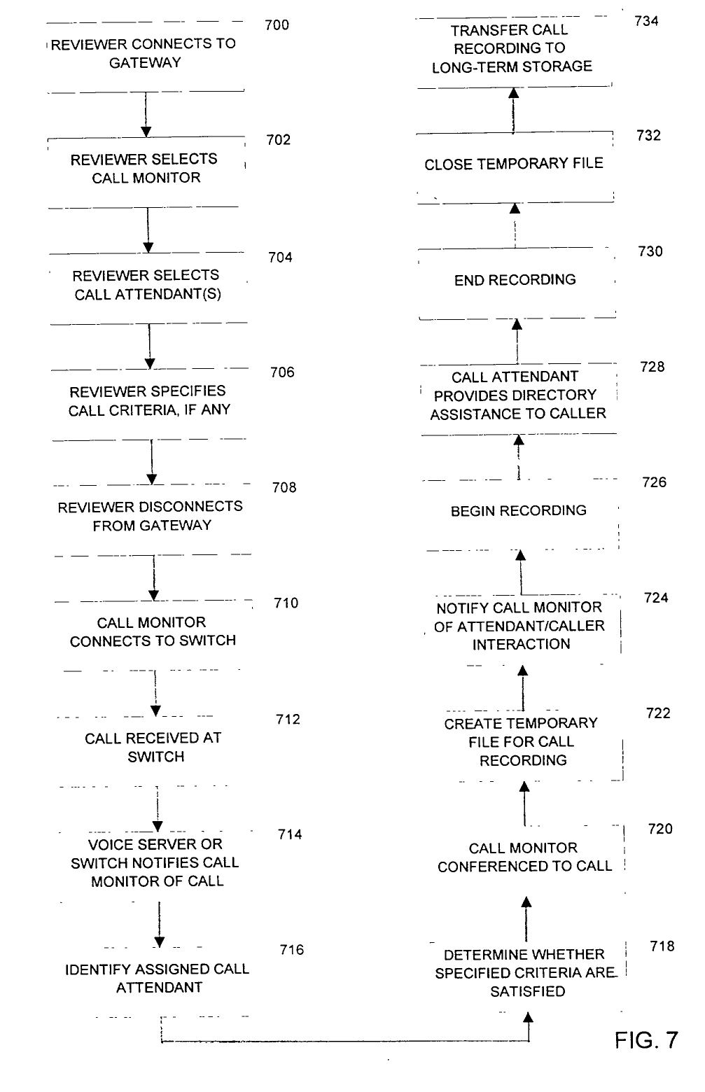

FIG. 7 depicts an alternative method of configuring call monitor 228 and recording calls handled by call center 100.

A reviewer at reviewer computer 130 or reviewer computer 132, such as a call center supervisor or an authorized representative of a customer service provider, connects (step 700) or logs into gateway 142. The reviewer than selects (step 702) a call monitor such as call monitor 228 in call center 100. Gateway 142 ensures that the reviewer is authorized to make or request call recordings on call monitor 228. Alternatively, the reviewer's computer is connected directly to call center 100 and call monitor 228.

In the presently illustrated embodiment, the reviewer selects (step 704) one or more call attendants within call center 100 that the reviewer desires to monitor. The reviewer may also specify (step 706) various criteria (described above) that must be met in order for a call to be recorded. The reviewer may, for example, specify that calls handled by the selected call attendant(s) are only to be recorded if they are from a specified telecommunications service provider (e.g., AT&T, Sprint), or from a specified caller (which may be identified by Mobile Identification Number, Automatic Numbering Identification, Electronic Serial Number, etc.), or that are received on a certain date, or in a certain time period, etc. The reviewer may also specify that target calls are only to be recorded for a certain period of time. The preceding criteria (and others such as those listed above) may, of course, be combined as necessary to meet the reviewer's needs.

After specifying his or her desired criteria, the reviewer disconnects (step 708) from gateway 142. In the illustrated embodiment, the call monitor then connects (step 710) to switch 204 via call monitor link 230 after being configured. In an alternative embodiment, however, call monitor 228 is connected to switch 204 even while being configured. The connection between switch 204 and call monitor 228 in such an embodiment is kept open until a target call (i.e., a call meeting the reviewer's specified criteria) is received.

In the illustrated embodiment, call center 100 continues operating normally, receiving and processing directory assistance calls, while call monitor 228 is configured and connected to switch 204. In the normal operation of call center 100, directory assistance calls are received over communication channels 202 by switch 204. Switch 204 retrieves from the call stream certain data concerning the caller, such as the caller's ANI, ESN or MIN, the area from which the call originated, and the telecommunication service provider that is delivering the call.

When a target call is received (step 712) at switch 204, voice server 224 may be notified of the arrival of the new call and connect to the call through voice server link 226 to play a greeting message for the caller. In order to play the appropriate greeting to the correct caller, voice server 224 is informed of the inbound channel 202a that the caller is connected to and which call attendant will be handling the call.

In the presently illustrated embodiment of the invention, voice server 224 or switch 204 then notifies (step 714) call monitor 228 of the arrival of a call and identifies (step 716) to the call monitor the call attendant that has been assigned to the call. If call monitor 228 has not been configured to record calls involving the assigned call attendant, the call is handled normally without being recorded.

When, however, call monitor 228 has been instructed to record calls handled by the assigned call attendant, the call monitor determines (step 718) whether the call meets the criteria, if any, that the reviewer specified. Where the specified criteria concern the caller (e.g., ANI, MIN, origination area of the call, service provider), call monitor 228 determines if the criteria are satisfied by querying switch 204, switch host computer 206, and/or data server 222. Where, however, the specified criteria concern a destination party or the duration of the call, information that cannot be determined until after the caller interacts with the assigned call center attendant, call monitor 228 may begin recording normally (as described below), but then cease recording if it turns out that the caller is not connecting to a target destination party or the call is not of sufficient duration.

If, based upon the assigned call attendant and specified call criteria, the call is to be recorded, call monitor 228 instructs switch 204 to conference it (step 720) to the call.

Call monitor 228 opens (step 722) a file on disk array 504 in which to temporarily store the recorded call. The call is stored in the temporary file until after the attendant/caller interaction ends and/or until the recording is compressed. At that time the call recording is stored in a more permanent form and/or location. For long-term storage purposes, each call recording receives a unique file name identifying the file in which the recording is stored long-term. The file name is composed of a string of characters representing various pieces of information concerning the recorded call. For example, the file name may include any or all of: MIN or ANI, service provider, call center, call attendant, date, time, etc.

In alternative embodiments of the invention, in which the file name of a call recording is not sufficient to identify the relevant criteria concerning the recorded call, call recordings are classified (and/or segregated) for storage and retrieval purposes based on any combination of the criteria (discussed above) that a reviewer may use to specify the calls that are to be recorded. Calls may, for example, be classified according to information such as the destination party that the calling customer wishes to reach, destination telephone number, city or geographical area from which the call originated, city or geographical area of destination party, date, time, call center, etc. Based on the classification of each recorded call, certain calls may continue to be stored locally within the call center, may be transferred to some other storage location, or may be deleted—either after a certain amount of time, or after a certain number of the same type of calls are recorded. The classification or criteria concerning a call recording may be stored in a database entry or other storage area associated with the call recording.

Before (or shortly after) the call attendant begins conversing with the caller, voice server 224 or switch 204 notifies (step 724) call monitor 228 that the attendant is about to interact (or is interacting) with the caller. Upon such notification, call monitor 228 commences (step 726) recording.

When a call attendant is connected to a caller in a typical directory assistance call, the call attendant elicits a directory assistance request, usually comprising a request for a telephone number of, and/or a transfer of the call to, a destination party that the caller wishes to talk to. The call attendant retrieves the desired telephone number, illustratively by reference to an electronic phone book. Before being connected to the destination party, however, voice server 224 may be reconnected to the call to play a closing message.

After the call attendant finishes providing directory assistance to the caller (step 728), call monitor 228 stops recording (step 730) and closes (step 732) the temporary call recording file. In the illustrated embodiment, call monitor 228 determines that the call attendant has finished providing assistance upon notification by voice server 224 that the voice server was instructed to play the closing message for the caller. Alternatively, call monitor 228 may continue recording for a specified period of time (e.g., ten minutes), until the caller hangs up, or until an extended period of silence is detected.

After the temporary file is closed, the call recording is transferred (step 734) to long-term storage. In the illustrated embodiment, the call recording is compressed in conjunction with being stored in the designated long-term file. The use of multiple call monitors speeds this task as one call monitor may perform the compression while another records other calls. In another embodiment, call recordings are compressed as they are stored in the temporary file. The step of changing the call recording from temporary to long-term storage may simply take the form of changing the name of the file in which the temporary recording is stored.

As discussed above, call recordings stored on call monitor 228 are, according to a present embodiment, identified by their file names at a minimum. In addition, a directory structure may be utilized such that all recordings of a specified call attendant are stored within one directory. Within that directory, subdirectories may be used to store calls relating to major categories of call criteria. For example, subdirectories may contain call recordings of calls received from different telecommunication service providers. Within each service provider's subdirectory, additional subdirectories may be established for other criteria identified above. A call recording may be stored in more than one directory or subdirectory. Thus, for security purposes in an alternative embodiment in which a customer or service provider is allowed limited access to call recordings, the customer may be permitted to access recordings in only selected directories or subdirectories.

Monitoring Calls in Real-Time

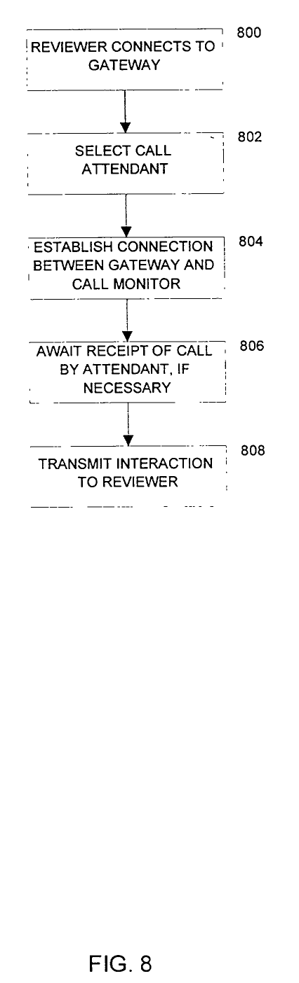

FIG. 8. depicts an illustrative method of monitoring attendant/caller interaction in real-time (or near real-time).

In step 800 a reviewer desiring to monitor an attendant's interaction in, or near, real-time connects to gateway 142. The reviewer then identifies (step 802) the call center attendant within call center 100 to be monitored, illustratively using menus or other graphical, textual, or audible means provided by gateway 142. The reviewer may need to first choose or identify call center 100 before selecting an individual call center attendant within the call center.

A connection is then established (step 804) between gateway 142 and call monitor 228 within call center 100. If, at the time the reviewer is connected to call monitor 228, the selected attendant is not handling a call, the reviewer may wait (step 806) for a call or choose to monitor a different attendant. In between calls handled by the selected attendant, the connection between call monitor 228 and gateway 142 (and from gateway 142 to the reviewer) is illustratively kept open. In such a mode of operation, an audible and/or visual alarm may be provided to the reviewer via his or her computer to alert him or her to the incipient interaction.

When a call is received by the selected attendant, call monitor 228 transmits (step 808) the attendant/caller interaction to gateway 142 and the connected reviewer as, or soon after, it occurs. Advantageously, the attendant/caller interaction is transmitted to the reviewer via a streaming audio feed.

Playing Calls According to One Embodiment of the Invention

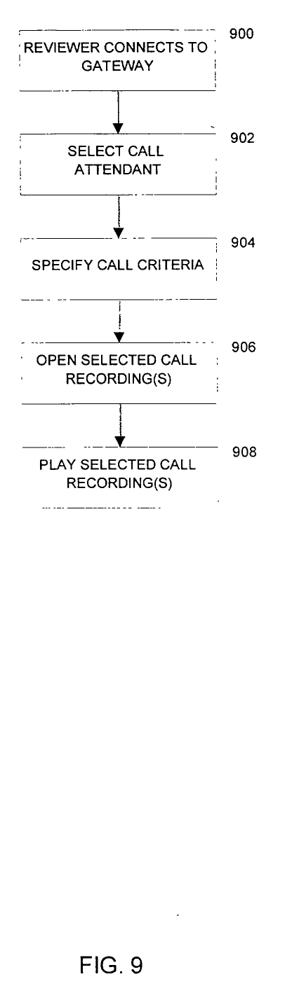

One method of playing a call recording is depicted in FIG. 9. In order to play a call recording stored on call monitor 228, a reviewer must first connect (step 900) to gateway 142. A method of connection as described above is suitable.

In an embodiment in which the reviewer accesses call recordings through gateway 142, commercial software such as CITRIX's WinFrame, which provides security via user accounts and passwords, may be employed. Therefore, in this embodiment, gateway 142 isolates call center 100 from the reviewer and performs (at the reviewer's behest) the actions now described in conjunction with FIG. 9.

In steps 902-904, the reviewer selects the call recordings he or she wants to review. In the presently illustrated embodiment the reviewer first selects (step 902) a particular call attendant or call attendants. The reviewer then specifies (step 904) the criteria, if any, concerning particular calls or types of calls he or she is interested in. In one alternative embodiment of the invention, in steps 902-904 the reviewer is presented with a list or menu of file names of call recordings. As described above, file names may contain various items of information concerning the associated recorded call, allowing the reviewer to simply select one or more files based on the encapsulated information.

A selected call recording is opened (step 906) and is played (step 908) by call monitor 228, across the reviewer's connection, on the reviewer's computer. RealNetworks' RealAudio software, which provides streaming audio feeds, is illustratively used on gateway 142 and/or call monitor 228 to play a call recording. In the illustrated embodiment of the invention, a streaming audio feed is employed to play the retrieved call recording so that the reviewer can quickly begin reviewing the recording without waiting for it to be downloaded to his or her computer.

Various embodiments of the invention have been described. The descriptions are intended to be illustrative, not limitative. Thus, it will be apparent to those skilled in the art that modifications may be made to the invention as described without departing from the scope of the claims set out below.

For example, in one alternative embodiment providing real-time monitor of attendant/caller interaction, the call monitor may still record the interaction, but the reviewer monitors the call in real-time or near real-time. The call monitor feeds the intercepted interaction to the reviewer computer where the interaction may be played on a speaker, converted into text for visual display, or otherwise transformed, recorded, or altered.

In a further embodiment of the invention, reviewers connected directly to call center 100 or call monitor 228, particularly those located within the call center, may monitor attendants and replay call recordings stored in the call center's call monitor without connecting through gateway 142. In such an embodiment, data server 222, voice server 224, call monitor 228, and/or switch host computer 206 provide the necessary web browser or other interface necessary to access the call monitor and call recordings. Reviewers external to the call center may also be granted access directly to the call center's network and/or call monitor rather than requiring them to interface via gateway 142.

Further, the interface provided by gateway 142 and/or call monitor 228 need not be a web browser or even graphical in appearance. A simple telephonic interface using touch tones is contemplated, as are various configurations of speech-to-text converters, text-to-speech converters (particularly useful where a caller interacts with an attendant via TTY), speech recognition, video, etc. The appearance of an attendant's terminal (e.g., forms, text and images displayed on an attendant's terminal 218 as shown in FIG. 2), possibly including keystrokes entered by the attendant, may even be recorded and/or reproduced for a reviewer.

What is claimed is:

1. A method of monitoring interaction between a call center attendant and a caller, comprising:
configuring a call monitor to record interaction between the attendant and a caller;
receiving a call at a call center switch from a caller;
connecting the attendant to the call;
conferencing the call monitor to the call;
monitoring the call for interaction between the caller and the attendant;
recording, on the call monitor, interaction between the caller and the attendant;
detecting an end to interaction between the caller and the attendant;
composing an identifier to be associated with the recorded interaction, said identifier including a characteristic of the recorded interaction; and
replaying the recorded interaction for a reviewer over a communication link established between the reviewer and the call monitor.

2. The method of claim 1 further comprising the step of compressing the recorded interaction.

3. The method of claim 1 wherein said configuring step comprises configuring the call monitor to record interaction between the attendant and the caller for all calls handled by the attendant.

4. The method of claim 1 wherein said detecting an end to interaction step comprises disconnecting the attendant from the call.

5. The method of claim 1 wherein said detecting an end to interaction step comprises detecting the disconnection of the caller from the call.

6. The method of claim 1 wherein said detecting an end to interaction step comprises detecting an extended period of time during which there is no interaction between the caller and the attendant.

7. The method of claim 1 wherein the identifier includes one or more of the following characteristics concerning the call: caller telephone number, destination telephone number, caller identification, destination party identification, geographical origination of the call, geographical destination of the call, date of the call, time of the call, service provider, call center, call center attendant, and duration of the call.

8. The method of claim 7 wherein the identifier is the name of a file in which the recorded interaction is stored.

9. The method of claim 7 wherein the identifier is an entry in a database.

10. The method of claim 1 wherein the replaying step comprises:
connecting a reviewer to a server;
establishing a communication link between the call monitor and the server;
receiving the reviewer's selection of the identifier associated with the recorded interaction; and
playing the recorded interaction over the communication link.

11. A method of monitoring call activity at a call center, the method comprising:
configuring a first call monitor to record a call center attendant's interaction with callers;
receiving a call from a caller;
connecting the attendant to the call;
conferencing the first call monitor to the call;
recording interaction between the attendant and the caller;
associating an identifier with said recorded interaction, said identifier including one or more characteristics of the call;
maintaining said recorded interaction for access by a reviewer via selection of said identifier; and
replaying the recorded interaction.

12. The method of claim 11 wherein said configuring step comprises specifying one or more of the following parameters: caller telephone number, destination telephone number, caller identification, destination party identification, geographical origination of a call, geographical destination of a call, date of a call, time of a call, service provider, call center, call center attendant, duration of a call, and random call selection.

13. The method of claim 11 wherein said maintaining step comprises the steps of:
connecting the first call monitor to an information server;
granting the reviewer access to the information server; and
allowing selection of said recorded interaction by the reviewer through the information server.

14. The method of claim 11 wherein said replaying step comprises playing the recorded interaction via a streaming audio feed.

15. The method of claim 11 wherein said replaying step comprises transmitting the recorded interaction via file transfer.

16. The method of claim 11 wherein said replaying step comprises converting the recorded interaction from speech to text.

17. The method of claim 11 wherein said recording step comprises the steps of:
storing a portion of the interaction between the attendant and the caller; and
compressing the recorded interaction.

18. The method of claim 17 wherein said storing step comprises recording a portion of verbal interaction between the caller and the attendant.

19. The method of claim 17 wherein said storing step comprises recording a portion of non-verbal interaction between the caller and the attendant.

20. The method of claim 17 wherein said compressing step is performed on a second call monitor.

21. The method of claim 11 wherein the identifier comprises one or more of the following: caller telephone number, destination telephone number, caller identification, destination party identification, geographical origination of the call, geographical destination of the call, date of the call, time of the call, service provider, call center, call center attendant, and duration of a call.

22. The method of claim 21 wherein said identifier comprises an entry in a database.

23. The method of claim 21 wherein said identifier comprises the name of a file in which said recorded interaction is stored.

24. A method of monitoring a call center attendant's interaction with a caller, comprising:
connecting a call from the caller to the call center attendant;
conferencing a call monitor to the call;
monitoring the call for interaction between the caller and the attendant;
establishing a communication link between the call monitor and a server;
connecting a reviewer to the server; and
transmitting interaction between the caller and the attendant to the reviewer over the communication link.

25. A method of reviewing call center assistance to a caller, comprising the steps of:
establishing a connection between a first call monitor and a call center switch;
connecting an operator to the call center switch;
configuring the first call monitor to record interaction between the operator and one or more callers;
receiving a call from the caller;
recording a portion of the operator's interaction with the caller;
connecting a second call monitor to a server;
connecting a reviewer to the server;
receiving a request from the reviewer, via the server, to replay the recorded interaction; and
replaying the recorded interaction from the second call monitor.

26. The method of claim 25 wherein the server includes a web browser or other graphical interface.

27. The method of claim 25 wherein the replaying step includes decompressing the recorded interaction.

28. The method of claim 25 wherein the replaying step includes converting the recorded interaction from text to speech.

29. The method of claim 25 wherein the replaying step includes playing the recorded interaction in a streaming audio feed.

30. The method of claim 25 wherein the replaying step includes transferring the recorded interaction via file transfer.

31. The method of claim 25 wherein the replaying step includes converting the recorded interaction from speech to text.

32. The method of claim 31 wherein the replaying step includes searching said text for a specified word or phrase.

33. The method of claim 25 wherein the first call monitor comprises the second call monitor.

34. An apparatus for monitoring call center assistance given to a caller, the apparatus comprising:
a switch;
a call center attendant;
a first network; and
a call monitor;
wherein the call monitor is connected to the first network, the switch, the call center attendant and the caller for the purpose of monitoring, in response to the caller's connection to the switch, interaction between the caller and the call center attendant.

35. The apparatus of claim 34 wherein the monitored interaction between the caller and the attendant is recorded on the call monitor.

36. The apparatus of claim 34 further comprising:
a server connected to the first network; and
a reviewer connected to the server;
wherein the reviewer connects to the server to configure the call monitor.

37. The apparatus of claim 36 wherein the reviewer connects to the server to review the interaction monitored by the call monitor.

38. The apparatus of claim 36 wherein the server is a web server.

39. The apparatus of claim 37 wherein the reviewer reviews the interaction while the call center attendant is interacting with the caller.

40. The apparatus of claim 35 further comprising:
a second network;
a computer for retrieving recorded interaction between the caller and the attendant, the computer being connected to the second network; and
a link between the first network and the second network;
wherein recorded interaction between the caller and the attendant is retrieved from the call monitor in the first network by the computer in the second network.

41. The apparatus of claim 40 wherein the second network is the internet.
